(19) United States
(12) Patent Application Publication
(10) Pub. No.: US 2023/0078400 A1
(43) Pub. Date: Mar. 16, 2023

(54) FAT COMPOSITION SUITABLE AS A COCOA BUTTER EQUIVALENT HAVING A LOW AMOUNT OF DIGLYCERIDES

(71) Applicant: AAK AB (publ), Malmö (SE)

(72) Inventor: Bjarne JUUL, Højbjerg (DK)

(21) Appl. No.: 17/800,777

(22) PCT Filed: Feb. 11, 2021
(86) PCT No.: PCT/SE2021/050099

§ 371 Date: Aug. 18, 2022

(30) Foreign Application Priority Data
Feb. 20, 2020 (SE) 2050191-2
Dec. 16, 2020 (SE) 2051474-1

(51) Int. Cl. A23G 1/38; A23D 7/00; A23D 7/005; A23D 9/02

(52) U.S. Cl. CPC A23G 1/38; A23D 7/003; A23D 7/0053; A23D 9/02

(57) ABSTRACT

The present invention relates to fat composition suitable for use as a cocoa butter equivalent, wherein the fat composition comprises triglycerides of which 60% by weight or more is Sat₂O, wherein Sat is selected from St, P, or combinations hereof; and wherein, in the fat composition, the total content of StOP+StPO+St₂O is 60% by weight or less, and the total amount of diglycerides (DAG) is 2.0% by weight or less; and wherein O is oleic acid, St is stearic acid, and P is palmitic acid.

### TECHNICAL FIELD OF THE INVENTION

The present invention relates to a fat composition suitable for use as a cocoa butter equivalent, preferably characterized by having a total amount of diglycerides (DAG) of 2.0% by weight or less.

The present invention also relates to uses of the fat composition.

### BACKGROUND OF THE INVENTION

For crude oil and fractions thereof from the polymorphic group characterized with more than 40% SatOSat like: Palm Mid Fraction (PMF), cocoa butter, Illipe oil, shea nut oil, etc., the existence of minor amounts of component like free fatty acid, monoglycerides, and diglycerides can have a negative effect of the subsequent application of the oil in a given product. The free fatty acid and the monoglycerides are usually removed during refining of the oil, but diglycerides (DAGs) are not removed in a normal refining process and remain unchanged within the given product.

Known methods exist to remove DAG from the given oil product. One such method is washing with alcohol. However, there is a risk of explosions when performing such method, and it is therefore preferred not to perform such method on a largescale fabrication system. It has therefore been accepted that DAG are present in the oil in certain amounts.

In chocolate manufacturing, cocoa butter may be fully or partially replaced by Cocoa Butter Equivalents (CBEs), which are often produced by mixing a vegetable fat with a high content of StOSt (more than 30%) and a vegetable fat with a high content of POP (more than 40%) in a ratio, such as from 20:80 to 80:20.

In todays market, for a given oil product such as a CBE, the focus is shifted more and more towards a high Buhler crystallization index (BCI) value, and the quality of said product is correlated with the BCI value. Therefore, the demand is towards a high BCI value oil product.

Further, todays producers are focusing on optimizing every production parameter in order to increase the speed of a production line and get much higher capacity on said production line.

Accordingly, the main object of the invention is to provide a fat composition suitable for use as a CBE comprising at least one fat composition characterized with more than 40% SatOSat, which is easy to handle, and which will be usable in production of confectionary products such as a chocolate.

Another object of the invention is to improve the BCI value of a fat composition or of a chocolate compound comprising the fat composition.

Yet another object of the invention is to increases the speed of a production line and get much higher capacity on said production line.

### SUMMARY OF THE INVENTION

The present invention relates to a fat composition suitable for use as a cocoa butter equivalent (CBE), wherein the fat composition comprises triglycerides of which 60% by weight or more is Sat₂O, wherein Sat is selected from St, P, or combinations hereof; and wherein, in the fat composition, the total content of StOP+StPO+St₂O is 60% by weight or less, and the total amount of diglycerides (DAG) is 2.0% by weight or less; and wherein O is oleic acid, St is stearic acid, and P is palmitic acid.

In one embodiment, the present invention relates to a fat composition suitable for use as a CBE, wherein the fat composition comprises between 20 and 80% by weight of a vegetable fat composition, wherein the vegetable fat composition comprises triglycerides of which at least 60% by weight is Sat₂O, and wherein, in the vegetable fat composition, the POP content is between 25 and 95% by weight.

Altogether, the fat composition according to the present invention is suitable for use as a CBE characterized by having a total amount of diglycerides (DAG) of 2.0% by weight or less.

By the present invention, it has surprisingly been found that the fat composition according to the present disclosure has a significant impact on the BCI value compared to a fat composition made with a similar fat having a higher amount of DAG.

The impact of the DAG on the BCI value in a fat composition or in a food product comprising the fat composition depends on the concentration of the DAG, the fat composition, and the type of DAG.

The fat composition comprising triglycerides of which 60% by weight or more is Sat₂O, wherein Sat is selected from St, P, or combinations hereof; and wherein, in the fat composition, the total content of StOP+StPO+St₂O is 60% by weight or less, and the total amount of diglycerides (DAG) is 2.0% by weight or less; and wherein O is oleic acid, St is stearic acid, and P is palmitic acid crystalizes significant faster and at a higher temperature than a similar fat composition having a higher DAG content as demonstrated by the higher BCI value.

The present invention further relates to the use of a fat composition suitable for use as a CBE, wherein the fat composition comprises triglycerides of which 60% by weight or more is Sat₂O, wherein Sat is selected from St, P, or combinations hereof; and wherein, in the fat composition, the total content of StOP+StPO+St₂O is 60% by weight or less, and the total amount of diglycerides (DAG) is 2.0% by weight or less; and wherein O is oleic acid, St is stearic acid, and P is palmitic acid, in the manufacture of a food product for human consumption.

The present invention also relates to the use of a fat composition suitable for use as a CBE, wherein the fat composition comprises triglycerides of which 60% by weight or more is Sat₂O, wherein Sat is selected from St, P, or combinations hereof; and wherein, in the fat composition, the total content of StOP+StPO+St₂O is 60% by weight or less, and the total amount of diglycerides (DAG) is 2.0% by weight or less; and wherein O is oleic acid, St is stearic acid, and P is palmitic acid, as an ingredient in a food product, such as a confectionary product or such as a chocolate or chocolate-like product or filling.

The food product, comprising the herein defined fat composition incorporated in the food product, has an improved BCI value which will reflect on the line capacity, which will be improved and also improve handling during manufacturing of the food product, while still having maintained the properties of a well-tempered product.

The present invention further relates to a method of manufacturing a fat composition suitable for use as a CBE according to the present disclosure, wherein the method comprises the steps of:
a) Providing a fat composition comprising triglycerides of which 60% by weight or more is Sat₂O, wherein Sat is selected from St, P, or combinations hereof; and wherein, in the fat composition, the total content of StOP+StPO+St₂O is 60% by weight or less, and wherein O is oleic acid, St is stearic acid, and P is palmitic acid;
b) Mixing said fat composition with a DAG-specific enzyme and water in a reaction container hereby obtaining a mixture;
c) Heating and stirring said mixture over a predefined period of time;
d) Separating the enzyme from the mixture and subsequently drying the mixture under reduced pressure to remove any excess water, thereby obtaining a fat composition comprising triglycerides of which 60% by weight or more is Sat₂O, wherein Sat is selected from St, P, or combinations hereof; and wherein, in the fat composition, the total content of StOP+StPO+St₂O is 60% by weight or less, and the total amount of diglycerides (DAG) is 2.0% by weight or less; and wherein O is oleic acid, St is stearic acid, and P is palmitic acid.

### Definitions

In the context of the present invention, the following terms are meant to comprise the following, unless defined elsewhere in the description.

The term “comprising” or “to comprise” is to be interpreted as specifying the presence of the stated parts, steps, features, or components, but does not exclude the presence of one or more additional parts, steps, features, or components.

The terms “oils” and “fats” are used for esters between fatty acids and glycerol. One molecule of glycerol can be esterified to one, two, and tree fatty acid molecules resulting in a monoglyceride (MAG), a diglyceride (DAG), or a triglyceride (TAG), respectively. Usually fats consist of mainly triglycerides and minor amounts of lecithin, sterols, etc. If the fat is liquid at room temperature, it is normally called oil. If the fat is semisolid at room temperature and of exotic origin it is often referred to as butter, e.g. shea butter. If it is solid at room temperature, it is normally called a fat. However, herein “oil” and “fat” is used interchangeably, unless otherwise specified.

As used herein, the term “vegetable” shall be understood as originating from a plant retaining its original chemical structure/composition or a single cell organism. Thus, vegetable fats or vegetable triglycerides are still to be understood as vegetable fats or vegetable triglycerides after fractionation etc. as long as the chemical structure of the fat components or the triglycerides are not altered. When vegetable triglycerides are for example transesterified they are no longer to be understood as a vegetable triglyceride in the present context.

As used herein the term “single cell oil” shall mean oil from oleaginous microorganisms which are species of yeasts, molds (fungal), bacteria and microalgae. These single cell oils are produced intracellular and in most cases during the stationary growth phase under specific growth conditions (e.g. under nitrogen limitation with simultaneous excess of a carbon source). Examples of oleaginous microorganisms are, but not limited to, Mortierella alpineea, Yarrowia lipolytica, Schizochytrium, Nannochloropsis, Chlorella, Crypthecodinium cohnii, Shewanella.

With respect to oils, fats, and related products in this context, reference is made to “Physical and Chemical Characteristics of Oils, Fats and Waxes”, AOCS, 1996, as well as “Lipid Glossary 2”, F. D. Gunstone, The Oily Press, 2004.

Sat means a saturated fatty acid, and U means an unsaturated fatty acid. The fatty acids, which are comprised in the triglycerides of formulae Sat₂U, SatUSat, etc., may be identical, or different, saturated and unsaturated fatty acids.

St means stearic acid/stearate (C18:0), O means oleic acid/oleate (C:18:1), P means palmitic acid (C16:0).

As used herein, the term “triglycerides” may be used interchangeably with the term “triacylglycerides” and should be understood as an ester derived from glycerol and three fatty acids. “Triglycerides” may be abbreviated TG or TAG.

As used herein, the term “diglycerides” may be used interchangeably with the term “diacylglycerides” and should be understood as an ester derived from glycerol and two fatty acids. “Diglycerides” may be abbreviated DG or DAG.

The % amount of a triglyceride (TAG) is determined using the AOCS Ce 5b-89 method which is a standard method for determining triglycerides in vegetable oils by HPLC. This method does not distinguish the different positional isomers of a given TAG, thus e.g. PPO and POP are measured as one.

In the embodiments where one may like to determine the individual positional isomers (such as the determination of the SatOSat/SatSatO ratio) the skilled person will know a method for determining positional isomers for example by High Performance Liquid Chromatography (HPLC) in combination with an Evaporative Light Scattering Detector (ELSD). The sample preparation consists of an epoxidation of the double bonds of unsaturated fatty acids. Alternatively, the ratio can be determined by means of High Performance Liquid Chromatography (HPLC) on Silver Ion columns and detected by ELSD. These methods are known and suitable methods are available at commercial laboratories, such as Reading Scientific Services Ltd. and Mylnefield Lipid Analysis.

By the ratio SatOSat/SatSatO is meant that the total weight (the sum) of all SatOSat TAGs is divided by the total weight (the sum) of all SatSatO TAGs.

As used herein “% by weight” relates to weight percentage i.e. wt %, wt. % or wt.-% if nothing else is indicated.

As used herein a “chocolate” is to be understood as a chocolate and/or chocolate-like product. By a chocolate-like product is meant a product, which at least is experienced by the consumer as chocolate or as a confectionery product having sensorial attributes common with chocolate, such as e.g. melting profile, taste etc. Some chocolate comprises cocoa butter, typically in substantial amounts, where some chocolate-like products may be produced with a low amount of or even without cocoa butter, e.g. by replacing the cocoa butter with a cocoa butter equivalent, cocoa butter substitute, etc. In addition, many chocolate products comprise cocoa powder or cocoa mass, although some chocolate products, such as typical white chocolates, may be produced without cocoa powder, but e.g. drawing its chocolate taste from cocoa butter. Depending on the country and/or region there may be various restrictions on which products may be marketed as chocolate.

The chocolate can also be a chocolate comprising milk fat, however without being labelled as “milk chocolate”. The European legislation states that in order for a chocolate to be labelled as a milk chocolate it should comprise a minimum of 3.5% by weight milk fat compared to the weight of the total chocolate recipe, which corresponds to 7-14% by weight of a standard chocolate's fat composition depending on fat content.

As used herein “cocoa butter equivalent” or CBE is intended to mean an edible fat having very similar chemical and physical properties to, and being compatible with, cocoa butter (CB). In both CB and CBEs, the main fatty acids are typically palmitic acid, stearic acid, and oleic acids. The triglycerides are typically 2-oleo di-saturated (Sat₂O). Cocoa butter equivalents are e.g. made from a mix of a palm mid fraction and a stearin fraction of shea stearin or another oil fraction rich in SatOSat triglycerides, where Sat is a saturated fatty acid having a chain length of C16 or longer, such as C16 and/or C18.

“Food products” comprise products for human consumption. Important groups of products are those where cocoa butter and cocoa butter-like fats are used.

For products and methods in the confectionery areas, reference is made to “Chocolate, Cocoa and Confectionery”, B. W. Minifie, Aspen Publishers Inc., 3. Edition 1999.

Palm Mid Fraction (PMF) is produced by multiple fractionation of palm oil. Its main characteristic is a very high content in symmetrical di-saturated triglycerides (mainly POP). In the present disclosure Palm Mid Fraction and PMF is used interchangeably.

Solid fat content (SFC) is a measure of the percentage of fat in crystalline (solid) phase to total fat (the remainder being in liquid phase) at a specific temperature or temperature range, measured across a temperature gradient.

### DETAILED DESCRIPTION OF THE INVENTION

When describing the below embodiments, the present invention envisages all possible combinations and permutations of the below described embodiments with the above disclosed aspects.

The present invention relates to fat composition suitable for use as a cocoa butter equivalent, wherein the fat composition comprises triglycerides of which 60% by weight or more is Sat₂O, wherein Sat is selected from St, P, or combinations hereof; and wherein, in the fat composition, the total content of StOP+StPO+St₂O is 60% by weight or less, and the total amount of diglycerides (DAG) is 2.0% by weight or less; and wherein O is oleic acid, St is stearic acid, and P is palmitic acid.

This invention demonstrates how it is possible to reduce the amount of DAG and thereby improve the BCI value significant for the produced fat composition alone as well as in a final food product, which e.g. can be a chocolate like compound or a filling, where the DAG reduced vegetable fat composition is a part of.

In addition, this invention demonstrates how it is possible to reduce the amount of DAG and thereby improve the crystallization behaviour significant for the fat composition alone as well as in a final food product, which e.g. can be a chocolate like compound or a filling, where the DAG reduced fat composition is a part of.

The present invention solves the problem of improving BCI value, crystallization speed and hardness significant by eliminating the DAG in a fat composition, such as a CBE.

In one or more embodiments the total amount of DAG is 1.8% by weight or less, such as 1.5% by weight or less, such as 1.2% by weight or less, such as 1.0% by weight or less, such as 0.8% by weight or less, such as 0.6% by weight or less or such as 0.5% by weight or less.

In one or more embodiments the total amount of DAG is 1.5% by weight or less.

In one or more embodiments, the amount of DAG in the fat composition is in the range of 0.2 to 2.0% by weight, such as in the range of 0.2 to 1.8% by weight, such as in the range of 0.2 to 1.5% by weight, such as in the range of 0.2 to 1.2% by weight, or such as in the range of 0.2 to 1.0% by weight.

In one or more embodiments, the fat composition has a Buhler crystallization index (BCI) value of 2.5 or more.

In one or more embodiments, the fat composition has a BCI value of at least 2.6, such as at least 2.7, such as at least 2.8, such as at least 2.9, such as at least 3.0, such as at least 3.2, such as at least 3.4, such as at least 3.6, such as at least 3.8, or such as at least 4.0.

In one or more embodiments, the fat composition has a BCI value between 2.5 and 6.0, such as between 3.0 and 5.5.

In one or more embodiments, the fat composition has a BCI value between 2.8 and 6.0, such as between 2.7 and 6.0, such as between 3.0 and 6.0, or such as between 3.5 and 6.0. In one or more embodiments, the fat composition has a BCI value between 4.0 and 6.0

An important production parameter of chocolate is its ability to crystallize fast in a stabile crystal form. The ability of a cocoa butter to add that ability to a chocolate is often evaluated by the so-called Buhler Crystallisation Index, BCI. The obtained BCI value is used in the chocolate and fat industry to predict the crystallization behavior of cocoa butter in a fast way. It is an empirical value, and a value above 3.5 is widely accepted as a good quality cocoa butter regarding crystallization behavior. Thus, the BCI value is an empirical value known in the art.

The BCI value of a Cocoa Butter Equivalent (CBE) that replaces cocoa butter 1:1 on other physical parameters is often below 2.5 and accordingly has a BCI value, which is significantly lower than the BCI value of cocoa butter. There is thus a need in the art for a fat composition suitable for use as a CBE with similar physical properties as cocoa butter and having a BCI value above 2.5.

The BCI value is an empirically value calculated based on a controlled cooling rate measured on a MultiTherm TC produced by Buhler. The experience in the chocolate industry is that the BCI value of the cocoa butter correlate well with the general crystallisation properties of the chocolate, i.e. a higher BCI value indicates easier tempering, higher tempering capacity, and faster crystallisation. Many chocolate producers use the value 3.5 as the minimum value, which they can accept for cocoa butter. CBEs have similar physical properties to cocoa butter, except for the fact that standard CBEs have a lower BCI value, often below 2.5.

It is shown in the examples that the BCI value for the fat compositions increase for the version of the fat composition having a low content of DAG compared the fat composition with a higher DAG content. This means that the fats with reduced DAG content will crystalize significant faster and at a higher temperature than the two fats having a higher DAG content as demonstrated by the higher BCI value (see table 2).

In one or more embodiments, the content of St₂O is 40% by weight or less, such as 38% by weight or less.

In one or more embodiments, the content of St₂O is between 25 and 40% by weight, such as between 25 and 38% by weight, such as between 27 and 38% by weight, such as between 30 and 38% by weight, or such as between 32 and 38% by weight.

In one or more embodiments, the content of St₂O is between 20 and 40% by weight, such as between 22 and 38% by weight, such as between 24 and 38% by weight, such as between 26 and 36% by weight, or such as between 28 and 36% by weight.

In one or more embodiments, the content of St₂O is between 20 and 35% by weight, such as between 22 and 32% by weight, such as between 24 and 30% by weight, or such as between 26 and 30% by weight.

In one or more embodiments, the total content of StOP+StPO+St₂O is 55% by weight or less, such as 52% by weight or less, such as 50% by weight or less, or such as 45% by weight or less. The total content of StOP+StPO+St₂O by weight is calculated as the sum the weight of StOP, StPO, and St₂O, i.e. ΣStOP+StPO+St₂O triglycerides by weight.

In one or more embodiments, the total content of StOP+StPO+St₂O is between 26 and 60% by weight, such as between 26 and 55% by weight, such as between 26 and 52% by weight, such as between 26 and 50% by weight, such as between 27 and 52% by weight, or such as between 27 and 50% by weight.

In one or more embodiments, the fat composition further comprises a fat and/or an oil originating from cocoa, mango, shea, illipe, sal, kokum, or combinations hereof.

In one or more embodiments, the fat composition comprises between 20 and 80% by weight of a vegetable fat composition, wherein the vegetable fat composition comprises triglycerides of which at least 60% by weight is Sat₂O, and wherein, in the vegetable fat composition, the POP content is between 25 and 95% by weight.

In a non-essential embodiment, the fat composition comprises between 20 and 80% by weight of a vegetable fat composition, wherein the vegetable fat composition comprises triglycerides of which at least 60% by weight is Sat₂O, and wherein, in the vegetable fat composition, the ratio of SatOSat/SatSatO is 12 or more, and the POP content is between 25 and 95% by weight. In one or more embodiments, the ratio of SatOSat/SatSatO is at least 14, such as at least 15, such as at least 16, such as at least 17, such as at least 18, such as at least 20, such as at least 21, such as at least 22, such as at least 23, such as at least 24, or such as at least 25. In one or more embodiments, the ratio of SatOSat/SatSatO is between 12 and 50, such as from 14 to 50, such as from 15 to 50, such as from 16 to 50, such as from 17 to 50, such as from 18 to 50 or such as from 20 to 50, such as 21 to 50, such as 22 to 50, such as 23 to 50, such as 24 to 50, such as 25 to 50. A higher ratio in SatOSat/SatSatO may affect the tempering properties and the crystallization speed of the fat component.

In one or more embodiments, the vegetable fat composition comprises triglycerides of which from 60 to 95% by weight is Sat₂O, such as from 60 to 90% by weight, such as from 60 to 85% by weight, or such as from 60 to 80% by weight.

In one or more embodiments, the POP content of the vegetable fat composition is from 30 to 95% by weight, such as from 30 to 90% by weight, such as from 30 to 80% by weight, such as from 40 to 75% by weight, or such as from 45 to 70% by weight.

In one or more embodiments, the POP content of the vegetable fat composition is from 30 to 95% by weight, such as from 30 to 90% by weight, such as from 30 to 80% by weight, such as from 30 to 75% by weight, or such as from 30 to 70% by weight.

In one or more embodiments, the POP content of the vegetable fat composition is from 40 to 95% by weight, such as from 40 to 90% by weight, such as from 40 to 80% by weight, such as from 40 to 75% by weight, or such as from 40 to 70% by weight.

In one or more embodiments, the POP content of the vegetable fat composition is from 45 to 95% by weight, such as from 45 to 90% by weight, such as from 45 to 80% by weight, such as from 45 to 75% by weight, or such as from 45 to 70% by weight.

In one or more embodiments, the POP content of the vegetable fat composition is from 35 to 75% by weight, such as from 40 to 75% by weight, such as from 45 to 75% by weight, or such as from 50 to 75% by weight.

In one or more embodiments, the POP content of the vegetable fat composition is from 35 to 70% by weight, such as from 40 to 70% by weight, such as from 45 to 70% by weight, or such as from 50 to 70% by weight.

In one or more embodiments, the vegetable fat composition comprises a total amount of DAG of 2.0% by weight or less, such as 1.8% by weight or less, such as 1.5% by weight or less, such as 1.2% by weight or less, such as 1.0% by weight or less, such as 0.8% by weight or less, such as 0.6% by weight or less or such as 0.5% by weight or less.

In one or more embodiments, the vegetable fat composition comprises monoglycerides (MAG) in a total amount of 1.0% by weight or less, such as 0.5% by weight or less, such as 0.2% by weight or less, or such as 0.1% by weight or less.

In one or more embodiments, the vegetable fat composition is a Palm Mid Fraction.

In one or more embodiments, the fat composition is a cocoa butter equivalent (CBE).

The present invention also relates to a fat composition as disclosed and described herein, wherein said fat composition is a CBE.

The present invention also relates to the use of a fat composition as disclosed and described herein in the manufacture of a food product for human consumption.

The present invention also relates to the use of a fat composition as disclosed and described herein as an ingredient in a food product.

The present invention also relates to the use of a fat composition as disclosed and described herein as an ingredient in a confectionary product.

The present invention also relates to the use of a fat composition as disclosed and described herein as an ingredient in a chocolate or chocolate-like product or filling.

As can be seen from the examples (table 3), the inflection point of the temper curve (i.e. the point where the tempering curve flattens out/reaches a plateau) is higher for the chocolate with the reduced amount of DAG, indicating that the crystallization during the subsequent cooling process will occur at a higher temperature, i.e. faster crystallization is achieved.

The present invention also relates to the use of a fat composition as disclosed and described herein as a filling fat in a confectionary product.

The present invention also relates to the use of a fat composition as disclosed and described herein as a filling fat in a chocolate or chocolate-like product.

In one or more embodiments, the vegetable fat composition is mixed with an oil originating from mango, shea, illipe, sal, kokum, or combinations hereof, to manufacture the cocoa butter equivalent (CBE).

The present invention also disclose a method of manufacturing a fat composition suitable for use as a CBE according to the present disclosure, wherein the method comprises the steps of:
a) Providing a fat composition comprising triglycerides of which 60% by weight or more is Sat₂O, wherein Sat is selected from St, P, or combinations hereof; and wherein, in the fat composition, the total content of StOP+StPO+St₂O is 60% by weight or less, and wherein O is oleic acid, St is stearic acid, and P is palmitic acid;
b) Mixing said fat composition with a DAG-specific enzyme and water in a reaction container hereby obtaining a mixture;
c) Heating and stirring said mixture over a predefined period of time;
d) Separating the enzyme from the mixture and subsequently drying the mixture under reduced pressure to remove any excess water, thereby obtaining a fat composition comprising triglycerides of which 60% by weight or more is Sat₂O, wherein Sat is selected from St, P, or combinations hereof; and wherein, in the fat composition, the total content of StOP+StPO+St₂O is 60% by weight or less, and the total amount of diglycerides (DAG) is 2.0% by weight or less; and wherein O is oleic acid, St is stearic acid, and P is palmitic acid.

The present invention also disclose a method of manufacturing a fat composition suitable for use as a CBE according to the present disclosure, wherein the method comprises the steps of:
a) Providing a vegetable fat composition, wherein the vegetable fat composition comprises triglycerides of which at least 60% by weight is Sat₂O, and wherein, in the vegetable fat composition, the POP content is between 25 and 95% by weight and further providing a shea stearin composition;
b) Mixing said vegetable fat composition with a DAG-specific enzyme and water in a first reaction container hereby obtaining a first mixture and further mixing said shea stearin composition with a DAG-specific enzyme and water in a second reaction container hereby obtaining a second mixture;
c) Heating and stirring each of said mixtures over a predefined period of time;
d) Separating the enzyme from each of the mixtures and subsequently drying each of the mixtures under reduced pressure to remove any excess water,
e) Mixing said two mixtures resulting from step d)—thereby obtaining a fat composition suitable for use as a cocoa butter equivalent, comprising triglycerides of which 60% by weight or more is Sat₂O, wherein Sat is selected from St, P, or combinations hereof; and wherein, in the fat composition, the total content of StOP+StPO+St₂O is 60% by weight or less, and the total amount of diglycerides (DAG) is 2.0% by weight or less; and wherein O is oleic acid, St is stearic acid, and P is palmitic acid.

In one or more embodiments, the resulting fat composition in step d, of the first listed method, and in step e, of the second listed method, comprises a total amount of DAG of 1.8% by weight or less, such as 1.5% by weight or less, such as 1.2% by weight or less, such as 1.0% by weight or less, such as 0.8% by weight or less, such as 0.6% by weight or less or such as 0.5% by weight or less.

In one or more embodiments, the amount of DAG in the resulting fat composition in step d, of the first listed method, and in step e, of the second listed method, is in the range of 0.2 to 2.0% by weight, such as in the range of 0.2 to 1.8% by weight, such as in the range of 0.2 to 1.5% by weight, such as in the range of 0.2 to 1.2% by weight, or such as in the range of 0.2 to 1.0% by weight.

In one or more embodiments, the resulting fat composition in step d, of the first listed method, and in step e, of the second listed method, has a Buhler crystallization index (BCI) value of 2.5 or more.

In one or more embodiments, the content of St₂O in the resulting fat composition in step d, of the first listed method, and in step e, of the second listed method, is 40% by weight or less, such as 38% by weight or less.

In one or more embodiments, the total content of StOP+StPO+St₂O in the resulting fat composition in step d, of the first listed method, and in step e, of the second listed method, is 55% by weight or less, such as 52% by weight or less, such as 50% by weight or less, or such as 45% by weight or less.

The present invention also disclose a method of manufacturing a fat composition suitable for use as a CBE according to the present disclosure, wherein the method comprises the steps of:
a) Providing a vegetable fat composition, wherein the vegetable fat composition comprises triglycerides of which at least 60% by weight is Sat₂O, and wherein, in the vegetable fat composition, the POP content is between 25 and 95% by weight;
b) Mixing said vegetable fat composition with a DAG-specific enzyme and water in a reaction container hereby obtaining a mixture;
c) Heating and stirring said mixture over a predefined period of time;
d) Separating the enzyme from the mixture and subsequently drying the mixture under reduced pressure to remove any excess water,
e) Mixing the mixture resulting from step d) with a shea stearin composition—thereby obtaining a fat composition suitable for use as a cocoa butter equivalent, comprising triglycerides of which 60% by weight or more is Sat₂O, wherein Sat is selected from St, P, or combinations hereof; and wherein, in the fat composition, the total content of StOP+StPO+St₂O is 60% by weight or less, and the total amount of diglycerides (DAG) is 2.0% by weight or less; and wherein O is oleic acid, St is stearic acid, and P is palmitic acid.

The present invention also disclose a method of manufacturing a fat composition suitable for use as a CBE according to the present disclosure, wherein the method comprises the steps of:
a) Providing a shea stearin composition;
b) Mixing said shea stearin composition with a DAG-specific enzyme and water in a reaction container hereby obtaining a second mixture;
c) Heating and stirring the mixture over a predefined period of time;
d) Separating the enzyme from the mixture and subsequently drying the mixture under reduced pressure to remove any excess water,
e) Mixing the mixture resulting from step d) with a vegetable fat composition, wherein the vegetable fat composition comprises triglycerides of which at least 60% by weight is Sat₂O, and wherein, in the vegetable fat composition, the POP content is between 25 and 95% by weight—thereby obtaining a fat composition suitable for use as a cocoa butter equivalent, comprising triglycerides of which 60% by weight or more is Sat₂O, wherein Sat is selected from St, P, or combinations hereof; and wherein, in the fat composition, the total content of StOP+StPO+St₂O is 60% by weight or less, and the total amount of diglycerides (DAG) is 2.0% by weight or less; and wherein O is oleic acid, St is stearic acid, and P is palmitic acid.

### EXAMPLES

### Example 1—Cocoa Butter Equivalent (CBE)

Table 1 shows four fat compositions. The first two fat compositions are two PMFs (fat A and B). Both are from the same batch, which is divided into two batches. Thus, fat A is the reference with the original DAG content, while fat B is the same fat as fat A, but with reduced DAG content made by using the process described herein below.

The third and fourth fat compositions are two shea stearins (fat C and D). Both are from the same batch, which is divided into two batches. Thus, fat C is the reference with the original DAG content, while fat D is the same fat as fat C, but with reduced DAG content made by using the process described herein below.

In order to remove the diglycerides from the fat compositions with a SatOSat content higher than 40%, which in the present example are a PMF and a shea stearin, but also could be e.g. cocoa butter or Illipe oil, the following process was performed: A 1 L jacketed vessel was used, equipped with an anchor-type stirrer. 600 g oil was added to the jacketed vessel together with 1% (w/w) of DAG-specific enzyme and 10% (w/w) water. The enzymes used in this example were Amano Lipase G (purchased from Sigma Aldrich). The stirring speed was set to 100 rpm and the water temperature in the jacket was set to 60° C. The mixture was left under these conditions for approximately 24 hours before the process was stopped. The liquid part was filtered from the enzymes and the oil was dried under vacuum removing any water present.

Instead of using a batch setup like the one described herein above, one could have immobilized the enzymes on a carrier. The oil could then be fed through this column containing the immobilized enzymes.

TABLE 1

| Fat composition | |
|---|---|
| PMF | Shea stearin |

| | A | B | C | D |
|---|---|---|---|---|
| POP #1 | 65.3 | 65.5 | 0.3 | 0.4 |
| POSt #1 | 13.4 | 13.4 | 8.0 | 8.1 |
| StOSt #1 | 1.7 | 1.7 | 68.7 | 68.6 |
| Monoglyceride #2 | <0.1 | <0.1 | <0.1 | <0.1 |
| Diglycerides #2 | 3.5 | 0.3 | 2.2 | 1.1 |
| Triglycerides #2 | 95.7 | 99.4 | 96.1 | 97.0 |

#1: The % amount of a triglyceride (TAG) is determined using the AOCS Ce 5b-89 method, which is a standard method for determining triglycerides in vegetable oils by HPLC.
#2: The % amount of TAG, MAG, and DAG is determined using the AOCS Cd 22-91 method, which is a standard method.

The fat compositions from table 1 are mixed to obtain four different cocoa butter equivalents (CBEs) according to table 2. Two reference CBEs with a standard amount of DAG content (E & G) and two CBEs with a reduced DAG content (F & H).

In this example the CBEs are obtained by mixing the PMF and the shea stearin after they have individually been subjected to the above process of reducing the amount of DAG, but another way to obtain the same results is to first mix the PMF and the shea stearin and then subjecting the mixture to the above process of reducing the amount of DAG.

TABLE 2

| | Fat composition | | | |
|---|---|---|---|---|
| | CBE I | | CBE II | |
| | E | F | G | H |
| | CBE I | CBE I | CBE II | CBE II |
| | Reference | with reduced DAG | Reference | with reduced DAG |
| % PMF A | 50 | — | 60 | — |
| % PMF B | — | 50 | — | 60 |
| % Shea stearin C | 50 | — | 40 | — |
| % Shea stearin D | — | 50 | — | 40 |
| POP #1 | 32.8 | 33.0 | 39.3 | 39.5 |
| POSt #1 | 10.7 | 10.8 | 11.2 | 11.3 |
| StOSt #1 | 35.2 | 35.2 | 28.4 | 28.5 |
| Monoglycerides #2 | <0.1 | <0.1 | <0.1 | <0.1 |
| Diglycerides #2 | 2.9 | 0.7 | 3.0 | 0.4 |
| Triglycerides #2 | 95.9 | 98.2 | 95.9 | 98.4 |
| Solid Fat Content 20° C. #3 | 73.9 | 77.9 | 72.0 | 77.2 |
| Solid Fat Content 25° C. #3 | 70.1 | 73.4 | 59.5 | 68.8 |
| Solid Fat Content 30° C. #3 | 57.9 | 61.1 | 38.7 | 54.1 |
| Solid Fat Content 35° C. #3 | 12.1 | 12.2 | 2.0 | 5.7 |
| Bühler crystallization Index | 3.2 | 5.5 | 2.6 | 4.3 |
| (BCI) #4 | | | | |
| Minutes to DSC | 32 | 24 | 39 | 29 |
| crystallization peak at | | | | |
| 18° C. isothermal #5 | | | | |
| DSC crystallization area at | 42.80 | 61.39 | 39.43 | 57.02 |
| 18° C. isothermal in J/g #5 | | | | |

#1: The % amount of a triglyceride (TAG) is determined using the AOCS Ce 5b-89 method, which is a standard method for determining triglycerides in vegetable oils by HPLC.
#2: The % amount of TAG, MAG, and DAG is determined using the AOCS Cd 22-91 method, which is a standard method.
#3: IUPAC 2.150b.
#4: MultiTherm ™ T/TC instrument. The method is described by the company Bühler who produce the instrument. Used method is the same as used for Cocoa butter.
#5: DSC on Mettler Toledo, Program X as described below. The sample size is 10 mg +/− 0.5 mg. The crystallization area at 16° C. is calculated in Joule/gram (J/g).

### Program X:

Isotherm 60° C. for 5 min, then

60° C.→18° C. at 10° C./min, then

Isotherm 18° C. for 120 min.

### Conclusion:

Example 1 shows two different CBEs, i.e. CBE I and CBE II (see table 2).

CBE I is an example of a CBE with a higher StOSt content and CBE II is an example of a CBE with a lower StOSt content. For both CBEs there are two variants. One reference with an ordinary DAG content (E and G) and one variant with a reduced DAG content (F and H).

From table 2 it is clear that for both CBEs a reduced content of DAG will make a significant harder fat, which is shown by a higher solid fat content (SFC) at four different temperatures. Especially at the critical temperature for a chocolate which is 30° C., it is very clear how much improvement in hardness a small reduction in DAG make for a CBE recipe, especially a CBE like CBE II (see table 2, SFC 30° C.). It is very interesting because the critical 30° C. SFC value is the value that informs a person skilled in the art how likely it is that one can handle the chocolate without the chocolate melts. When this value is high it is a indicator that it is possible to handle the chocolate without it melting before one gets to eat it.

The significant higher BCI value for the two CBEs having a low content of DAG (F and H, table 2), demonstrates an improvement of the crystallization time which are closely connected to a higher production line capacity and thereby a significant production cost reduction.

The DSC results further support this by showing a larger and faster crystallization area at 18° C. isothermal holding temperature for the two CBEs having a low content of DAG (F and H, table 2) compared to the two CBEs having a higher content of DAG (E and G, table 2) when using program X.

It is therefore shown that by reducing the DAG content in two different CBEs a very clear improvement in the crystallization speed and hardness is obtained for the DAG reduced CBEs.

### Example 2—Chocolates

Two chocolates are made by using CBE-E and CBE-F by using recipe X and Y as seen in table 3.

All ingredients, except a part of the fat and lecithin, are mixed in a Teddy Mixer with heat jacket at 50° C. to a texture like marzipan. Both mixtures are refined afterwards on a three rolls Buhler refiner to an average particle size at 20 microns. The refined mass is chonched together with the remaining fat for 6 hours at 50° C. on a Teddy mixer. The lecithin is added 0.5 hours before the chonching is finished.

A BCI value is measured at 20° C. and crystallization time and area is measured with DSC.

The chocolate is transferred to an Aasted tempering machine (AMC 50) and both chocolates are optimised to highest possible inflexion point at highest possible outlet temperature while still being well tempered.

The inflection point correlates to the crystallization point of the product.

TABLE 3

| | Recipe for chocolate | |
|---|---|---|
| | | Chocolate Y |
| | Chocolate X | with reduced |
| | Reference | DAG content |
| Sugar | 49.58 | 49.58 |
| CBE - E reference, from table 2 | 23.00 | — |
| CBE - F with reduced DAG content, | — | 23.00 |
| from table 2 | | |
| Cocoa powder (10-12% fat) - Alkalized | 12.00 | 12.00 |
| Cocoa mass | 15.00 | 15.00 |
| Lecithin | 0.40 | 0.40 |
| Vanillin | 0.02 | 0.02 |
| Total fat content | 32.7 | 32.7 |
| Bühler crystallization Index (BCI) #6 | 2.4 | 3.7 |
| Minutes to DSC crystallization peak at | 26 | 20 |
| 20° C. isothermal #7 | | |
| DSC crystallization area at 20° C. | 14.84 | 18.97 |
| isothermal J/g #8 | | |
| Inflection point ° C. #7 | 24.65 | 25.04 |

#6: MultiTherm ™ T/TC instrument. The method is described of the company Bühler who produce the instrument. Used method is the same as used for Chocolate.
#7: Measured on an Exothermal 7400 temper meter.
#8: DSC on Mettler Toledo DSC 823e, Program Y as described below. The sample size is 10 mg +/− 0.5 mg. The crystallization area at 20° C. is calculated in Joule/gram (J/g).

### Program Y:

Isotherm 60° C. for 5 min, then

60° C.→20° C. at 10° C./min, then

Isotherm 20° C. for 120 min.

### Conclusion:

The BCI value in table 3 shows how the improvement in the CBEs is reflected also as an improvement of the BCI value in the final chocolate compound. A BCI value above 3.5 for cocoa butter is found as high quality among chocolate producers.

This effect is further supported by the DSC measurement. A shorter crystallization time at the isothermal cooling step and a significant higher enthalpy of crystallization for the DAG reduced chocolate (chocolate Y) compared the same chocolate with higher DAG content (chocolate X) is shown.

The higher inflection point for the tempered chocolate Y supports the faster crystallization during the tempering process when using the DAG reduced CBE I compared to chocolate X which are based on the CBE I with higher DAG content.

The invention is described in the following items.
1. A fat composition suitable for use as a cocoa butter equivalent, wherein the fat composition comprises triglycerides of which 60% by weight or more is Sat₂O, wherein Sat is selected from St, P, or combinations hereof; and wherein, in the fat composition, the total content of StOP+StPO+St₂O is 60% by weight or less, and the total amount of diglycerides (DAG) is 2.0% by weight or less; and wherein O is oleic acid, St is stearic acid, and P is palmitic acid.
2. The fat composition according to any of the preceding claims, wherein the total amount of DAG is 1.8% by weight or less, such as 1.5% by weight or less, such as 1.2% by weight or less, such as 1.0% by weight or less, such as 0.8% by weight or less, such as 0.6% by weight or less or such as 0.5% by weight or less.
3. The fat composition according to claim 1, wherein the fat composition has a Bühler crystallization index (BCI) value of 2.5 or more.
4. The fat composition according to claim 3, wherein the fat composition has a BCI value of at least 2.6, such as at least 2.7, such as at least 2.8, such as at least 2.9, such as at least 3.0, such as at least 3.2, such as at least 3.4, such as at least 3.6, such as at least 3.8, or such as at least 4.0.
5. The fat composition according to any of the preceding claims, wherein the fat composition has a BCI value between 2.5 and 6.0, such as between 3.0 and 5.5.
6. The fat composition according to any of the preceding claims, wherein the fat composition has a BCI value between 4.0 and 6.0.
7. The fat composition according to any of the preceding claims, wherein, in the fat composition, the content of St₂O is 40% by weight or less, such as 38% by weight or less.
8. The fat composition according to claim 7, wherein the content of St₂O is between 25 and 40% by weight, such as between 25 and 38% by weight, such as between 27 and 38% by weight, such as between 30 and 38% by weight, or such as between 32 and 38% by weight.
9. The fat composition according to any of the preceding claims, wherein the total content of StOP+StPO+St₂O is 55% by weight or less, such as 52% by weight or less, such as 50% by weight or less.
10. The fat composition according to any of the preceding claims, wherein the total content of StOP+StPO+St₂O is between 26 and 60% by weight, such as between 26 and 55% by weight, such as between 26 and 52% by weight, such as between 26 and 50% by weight, such as between 27 and 52% by weight, or such as between 27 and 50% by weight.
11. The fat composition according to any of the preceding claims, wherein the fat composition further comprises a fat and/or an oil originating from cocoa, mango, shea, illipe, sal, kokum, or combinations hereof.
12. The fat composition according to any of the preceding claims, wherein the fat composition comprises between 20 and 80% by weight of a vegetable fat composition, wherein the vegetable fat composition comprises triglycerides of which at least 60% by weight is Sat₂O, and wherein, in the vegetable fat composition, the POP content is between 25 and 95% by weight.
13. The fat composition according to any of claim 12, wherein the ratio of SatOSat/SatSatO is 12 or more.
14. The fat composition according to any of claim 12 or 13, wherein the ratio of SatOSat/SatSatO is at least 14, such as at least 15, such as at least 16, such as at least 17, such as at least 18, such as at least 20, such as at least 21, such as at least 22, such as at least 23, such as at least 24, or such as at least 25.
15. The fat composition according to any of claims 12-14, wherein the vegetable fat composition comprises triglycerides of which from 60 to 95% by weight is Sat₂O, such as from 60 to 90% by weight, such as from 60 to 85% by weight, or such as from 60 to 80% by weight.
16. The fat composition according to any of claims 12-15, wherein the POP content of the vegetable fat composition is from 30 to 95% by weight, such as from 30 to 90% by weight, such as from 30 to 80% by weight, such as from 40 to 75% by weight, or such as from 45 to 70% by weight.
17. The fat composition according to any of claims 12-16, wherein the vegetable fat composition comprises a total amount of DAG of 2.0% by weight or less, such as 1.8% by weight or less, such as 1.5% by weight or less, such as 1.2% by weight or less, such as 1.0% by weight or less, such as 0.8% by weight or less, such as 0.6% by weight or less or such as 0.5% by weight or less.
18. The fat composition according to any of claims 12-17, wherein the vegetable fat composition comprises monoglycerides (MAG) in a total amount of 1.0% by weight or less, such as 0.5% by weight or less, such as 0.2% by weight or less, or such as 0.1% by weight or less.
19. The fat composition according to any of claims 12-18, wherein the vegetable fat composition is a Palm Mid Fraction.
20. The fat composition according to any of the preceding claims, wherein said fat composition is a cocoa butter equivalent (CBE).
21. Use of the fat composition according to any one of the preceding claims in the manufacture of a food product for human consumption.
22. Use of the fat composition according to any one of the claims 1-20 as an ingredient in a food product.
23. Use according to claim 22, wherein said food product is a confectionary product.
24. Use according to claim 23, wherein said confectionary product is a chocolate or chocolate-like product or filling.
25. A method of manufacturing a fat composition suitable for use as a CBE according to any of items 1 to 20, wherein the method comprises the steps of:
   a) Providing a fat composition comprising triglycerides of which 60% by weight or more is Sat₂O, wherein Sat is selected from St, P, or combinations hereof; and wherein, in the fat composition, the total content of StOP+StPO+St₂O is 60% by weight or less, and wherein 0 is oleic acid, St is stearic acid, and P is palmitic acid;
   b) Mixing said fat composition with a DAG-specific enzyme and water in a reaction container hereby obtaining a mixture;
   c) Heating and stirring said mixture over a predefined period of time;
   d) Separating the enzyme from the mixture and subsequently drying the mixture under reduced pressure to remove any excess water, thereby obtaining a fat composition comprising triglycerides of which 60% by weight or more is Sat₂O, wherein Sat is selected from St, P, or combinations hereof; and wherein, in the fat composition, the total content of StOP+StPO+St₂O is 60% by weight or less, and the total amount of diglycerides (DAG) is 2.0% by weight or less; and wherein 0 is oleic acid, St is stearic acid, and P is palmitic acid.
26. A method of manufacturing a fat composition suitable for use as a CBE according to any of items 1 to 20, wherein the method comprises the steps of:
   a) Providing a vegetable fat composition, wherein the vegetable fat composition comprises triglycerides of which at least 60% by weight is Sat₂O, and wherein, in the vegetable fat composition, the POP content is between 25 and 95% by weight and further providing a shea stearin composition;
   b) Mixing said vegetable fat composition with a DAG-specific enzyme and water in a first reaction container hereby obtaining a first mixture and further mixing said shea stearin composition with a DAG-specific enzyme and water in a second reaction container hereby obtaining a second mixture;
   c) Heating and stirring each of said mixtures over a predefined period of time;
   d) Separating the enzyme from each of the mixtures and subsequently drying each of the mixtures under reduced pressure to remove any excess water,
   e) Mixing said two mixtures resulting from step d)—thereby obtaining a fat composition suitable for use as a cocoa butter equivalent, comprising triglycerides of which 60% by weight or more is Sat₂O, wherein Sat is selected from St, P, or combinations hereof; and wherein, in the fat composition, the total content of StOP+StPO+St₂O is 60% by weight or less, and the total amount of diglycerides (DAG) is 2.0% by weight or less; and wherein O is oleic acid, St is stearic acid, and P is palmitic acid.

1-18. (canceled)

19. A fat composition comprising triglycerides of which 60% by weight or more is Sat₂O, wherein Sat is selected from St, P, or combinations hereof; and wherein, in the fat composition, the total content of StOP+StPO+St₂O is 60% by weight or less, and the total amount of diglycerides (DAG) is 2.0% by weight or less; and wherein O is oleic acid, St is stearic acid, and P is palmitic acid.

20. The fat composition according to claim 19, wherein the total amount of DAG is 1.8% by weight or less.

21. The fat composition according to claim 19, wherein the fat composition has a Buhler crystallization index (BCI) value of 2.5 or more.

22. The fat composition according to claim 19, wherein the fat composition has a BCI value between 4.0 and 6.0.

23. The fat composition according to claim 19, wherein, in the fat composition, the content of St₂O is 40% by weight or less.

24. The fat composition according to claim 19, wherein the total content of StOP+StPO+St₂O is 55% by weight or less.

25. The fat composition according to claim 19, wherein the total content of StOP+StPO+St₂O is between 26 and 60% by weight.

26. The fat composition according to claim 19, wherein the fat composition further comprises a fat and/or an oil originating from the group consisting of cocoa, mango, shea, illipe, sal, kokum, and combinations hereof.

27. The fat composition according to claim 19, wherein the fat composition comprises between 20 and 80% by weight of a vegetable fat composition, wherein the vegetable fat composition comprises triglycerides of which at least 60% by weight is Sat₂O, and wherein, in the vegetable fat composition, the POP content is between 25 and 95% by weight.

28. The fat composition according to claim 27, wherein the vegetable fat composition comprises triglycerides of which from 60 to 95% by weight is Sat₂O.

29. The fat composition according to claim 27, wherein the POP content of the vegetable fat composition is from 30 to 95% by weight.

30. The fat composition according to claim 27, wherein the vegetable fat composition comprises a total amount of DAG of 2.0% by weight or less.

31. The fat composition according to claim 27, wherein the vegetable fat composition is a Palm Mid Fraction.

32. The fat composition according to claim 19 wherein said fat composition is a cocoa butter equivalent (CBE).

33. A food product comprising a fat composition of claim 19.

34. The food product of claim 33, where the food product is a confectionary product.

35. The food product of claim 34, wherein the confectionary product is a chocolate or chocolate-like product or filling.

36. A method of manufacturing a fat composition suitable for use as a CBE according to any of claim 19, wherein the method comprises the steps of:
a) Providing a fat composition comprising triglycerides of which 60% by weight or more is Sat₂O, wherein Sat is selected from St, P, or combinations hereof; and wherein, in the fat composition, the total content of StOP+StPO+St₂O is 60% by weight or less, and wherein O is oleic acid, St is stearic acid, and P is palmitic acid;
b) Mixing said fat composition with a DAG-specific enzyme and water in a reaction container hereby obtaining a mixture;
c) Heating and stirring said mixture over a predefined period of time;
d) Separating the enzyme from the mixture and subsequently drying the mixture under reduced pressure to remove any excess water, thereby obtaining a fat composition comprising triglycerides of which 60% by weight or more is Sat₂O, wherein Sat is selected from St, P, or combinations hereof; and wherein, in the fat composition, the total content of StOP+StPO+St₂₀ is 60% by weight or less, and the total amount of diglycerides (DAG) is 2.0% by weight or less; and wherein O is oleic acid, St is stearic acid, and P is palmitic acid.

37. A method of manufacturing a fat composition suitable for use as a CBE according to claim 19, wherein the method comprises the steps of:
a) Providing a vegetable fat composition, wherein the vegetable fat composition comprises triglycerides of which at least 60% by weight is Sat₂O, and wherein, in the vegetable fat composition, the POP content is between 25 and 95% by weight and further providing a shea stearin composition;
b) Mixing said vegetable fat composition with a DAG-specific enzyme and water in a first reaction container hereby obtaining a first mixture and further mixing said shea stearin composition with a DAG-specific enzyme and water in a second reaction container hereby obtaining a second mixture;
c) Heating and stirring each of said mixtures over a predefined period of time;
d) Separating the enzyme from each of the mixtures and subsequently drying each of the mixtures under reduced pressure to remove any excess water,
e) Mixing said two mixtures resulting from step d)—thereby obtaining a fat composition suitable for use as a cocoa butter equivalent, comprising triglycerides of which 60% by weight or more is Sat₂O, wherein Sat is selected from St, P, or combinations hereof; and wherein, in the fat composition, the total content of StOP+StPO+St₂O is 60% by weight or less, and the total amount of diglycerides (DAG) is 2.0% by weight or less; and wherein O is oleic acid, St is stearic acid, and P is palmitic acid.
